(19) United States
(12) Patent Application Publication
(10) Pub. No.: US 2026/0243495 A1
(43) Pub. Date: Aug. 20, 2026

(54) REFRIGERATOR HINGE

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Hong Zuo, Hefei (CN); Zhen Jin, Hefei (CN); Zhanwei Liu, Hefei (CN)

(21) Appl. No.: 19/161,232

(22) PCT Filed: Nov. 20, 2024
(86) PCT No.: PCT/CN2024/133159

§ 371 Date: Aug. 30, 2025

(30) Foreign Application Priority Data
Nov. 27, 2023 (CN) 202323218961.3
Aug. 26, 2024 (CN) 202422091217.X

(51) Int. Cl. F25D 23/02; E05D 3/02; E05D 11/00

(52) U.S. Cl. CPC F25D 23/028; E05D 3/02; E05D 11/00; E05Y 2201/686; E05Y 2201/716; E05Y 2201/722; E05Y 2900/31; F25D 2323/024; F25D 2400/18; F25D 2500/02

(57) ABSTRACT

A hinge assembly for a refrigerator includes a first connector attached to a door panel, a second connector attached to a cabinet, and a third connector attached to an outer decorative panel. Transmission mechanisms are provided between the connectors. The decorative panel is stacked on the door panel. The first connector moves the door panel relative to the cabinet during opening and closing, while the third connector causes the decorative panel to slide along the door panel. A reversing transmission assembly is arranged on the first connector and engages with the decorative panel to facilitate sliding during door movement.

### CROSS-REFERENCES TO RELATED APPLICATIONS

The present application claims priorities to Chinese patent application No. 202323218961.3 filed on Nov. 27, 2023, entitled “Refrigerator Hinge”, and Chinese patent application No. 202422091217.X filed on Aug. 26, 2024, entitled “Refrigerator Hinge”, both of which are hereby incorporated by reference in their entireties.

### FIELD

The present application relates to the field of hinges, in particular to a refrigerator hinge.

### BACKGROUND

A refrigerator door body includes a door panel and a refrigerator door outer decorative panel fixed on the door panel, and the refrigerator door body is relatively thick due to the overlap between the refrigerator door outer decorative panel and the door panel. In a case that the refrigerator door body is relatively thick, if a fitting gap between the refrigerator door body and a cabinet is relatively small, one end of the refrigerator door body is likely to collide with the cabinet when the refrigerator door body is opened, causing the refrigerator door body to be easily damaged. Therefore, the fitting gap between the refrigerator door body and the cabinet needs to be set relatively large to avoid interference between the refrigerator door body and the refrigerator cabinet when the refrigerator door body is opened.

A traditional refrigerator hinge includes a second connector, and a first hinge connector rotatably connected to the second connector, where the second connector is fixed to a refrigerator cabinet, and the first hinge connector is hinged to an entire refrigerator door body. When a fitting gap between the refrigerator door body and the refrigerator cabinet is relatively small, it is easy to cause one end of a refrigerator door outer decorative panel to interfere with the refrigerator cabinet when the refrigerator door body is opened. Moreover, due to machining errors, after the refrigerator door outer decorative panel is assembled, when an assembler debugs and opens the refrigerator door body, the refrigerator door outer decorative panel may also interfere with the refrigerator cabinet.

### BRIEF SUMMARY

The present application aims to provide a refrigerator hinge, where a first connector is provided with a reversing transmission assembly in fit connection with a refrigerator door outer decorative panel, and when a refrigerator door panel is opened or closed, the refrigerator door outer decorative panel slides on the door panel. Thus, when the refrigerator door panel is opened, the refrigerator door outer decorative panel does not interfere with a refrigerator cabinet, and a fitting gap between the refrigerator door panel and the refrigerator cabinet need not be set to be too large. In addition, the machining precision requirement of the refrigerator door outer decorative panel can also be reduced.

A refrigerator hinge includes a first connector connected to a refrigerator door panel, a second connector connected to a refrigerator cabinet, and a third connector connected to a refrigerator door outer decorative panel, in which a transmission mechanism is provided among the first connector, the second connector, and the third connector, the refrigerator door outer decorative panel and the refrigerator door panel are stacked, the first connector drives the refrigerator door panel to be opened or closed on the refrigerator cabinet by means of the transmission mechanism, and the third connector drives the refrigerator door outer decorative panel to slide at the refrigerator door panel during opening or closing of the refrigerator door panel by means of the transmission mechanism.

The first connector is provided with a reversing transmission assembly in fit connection with the refrigerator door outer decorative panel, and when the refrigerator door panel is opened or closed, the refrigerator door outer decorative panel slides on the door panel. Thus, when the refrigerator door panel is opened, the refrigerator door outer decorative panel does not interfere with the refrigerator cabinet, and a fitting gap between the refrigerator door panel and the refrigerator cabinet need not be set to be too large. In addition, the machining precision requirement of the refrigerator door outer decorative panel can also be reduced.

The first connector is hinged to the second connector, and the transmission mechanism includes a rotation shaft provided between the first connector and the second connector. The first connector is rotationally positioned at the second connector via the rotation shaft, to allow the refrigerator door panel connected to the first connector to be rotationally opened or closed on the refrigerator cabinet.

The transmission mechanism further includes a link provided between the first connector and the second connector, and a reversing transmission assembly matched with the link, in which a first end of the link is connected to the second connector, a second end of the link is connected to the reversing transmission assembly, and a reversing output end of the reversing transmission assembly is connected to the third connector.

The link and the rotation shaft are provided at intervals between the first connector and the second connector.

During the opening of the refrigerator door panel from the refrigerator cabinet via the first connector, the first connector drives the link and the reversing transmission assembly to move, and the reversing output end of the reversing transmission assembly acts on the third connector, to allow the refrigerator door outer decorative panel connected to the third connector to slide at the refrigerator door panel in a direction away from the refrigerator cabinet when the refrigerator door panel is opened.

During the closing of the refrigerator door panel to the refrigerator cabinet via the first connector, the first connector drives the link and the reversing transmission assembly to move, and the reversing output end of the reversing transmission assembly acts on the third connector, to allow the refrigerator door outer decorative panel connected to the third connector to slide at the refrigerator door panel in a direction close to the refrigerator cabinet when the refrigerator door panel is closed.

When the refrigerator door panel rotates to be opened, the link drives the refrigerator door outer decorative panel to move outward at the same time, effectively preventing the refrigerator door outer decorative panel from interfering with the refrigerator cabinet when the refrigerator door panel is opened, and avoiding damage to the refrigerator door outer decorative panel.

The first connector is provided with a limit slide slot, and the second end of the link is provided with a limit post connected to the reversing transmission assembly. During the opening/closing of the refrigerator door panel from/to the refrigerator cabinet via the first connector, the limit post of the link moves in a limited manner on the limit slide slot and drives the reversing transmission assembly to move.

The reversing transmission assembly moves on the first connector by means of the limit post sliding on the limit slide slot.

The first connector is provided with an inner cavity for accommodating and mounting the reversing transmission assembly. The reversing transmission assembly includes a gear and a slider, in which the slider and the third connector are respectively in transmission connection with the gear, and the slider is provided with a connection block connected to the second end of the link.

During the opening/closing of the refrigerator door panel, the first connector drives the link and the slider to move, the slider moves and drives the gear to rotate, and the gear rotates and drives the third connector, to allow the refrigerator door outer decorative panel to slide at the refrigerator door panel.

The movement directions of the slider and the third connector are opposite. The slider is provided with first meshing teeth meshed with the gear, and the third connector is provided with second meshing teeth meshed with the gear. The slider drives, when sliding, the gear to rotate, and the gear rotates and drives the third connector and the refrigerator door outer decorative panel to slide.

A first linear slidably-connected fit position is provided between the slider and the first connector, and the slider is configured to linearly slide at the first connector via the first linear slidably-connected fit position. A second linear slidably-connected fit position is provided between the third connector and the first connector, and the third connector is configured to linearly slide at the first connector via the second linear slidably-connected fit position.

The first connector is provided with a rotation post fit with the gear, and the gear is rotationally positioned at the first connector via the rotation post when being rotated.

The first connector is provided with a bottom cover for packaging the gear, the slider and the third connector in the inner cavity of the first connector.

The first connector is provided with an opening at a location corresponding to the connection between the third connector and the refrigerator door outer decorative panel, and the third connector is provided with a fixation block in fit connection with the refrigerator door outer decorative panel. The fixation block slides in a limited manner within the opening when the third connector and the refrigerator door outer decorative panel slide, effectively controlling the maximum sliding displacement of the refrigerator door outer decorative panel during the opening/closing of the refrigerator door panel.

The beneficial effects of the present application are as follows.

A first connector is provided with a reversing transmission assembly in fit connection with a refrigerator door outer decorative panel, and when a refrigerator door panel is opened or closed, the refrigerator door outer decorative panel slides on the door panel. Thus, when the refrigerator door panel is opened, the refrigerator door outer decorative panel does not interfere with a refrigerator cabinet, and a fitting gap between the refrigerator door panel and the refrigerator cabinet need not be set to be too large. In addition, the machining precision requirement of the refrigerator door outer decorative panel can also be reduced.

### BRIEF DESCRIPTION OF THE DRAWINGS

To more clearly illustrate the technical solutions in the embodiments of the present application or related technologies, the drawings used in the embodiments or related technical description are briefly described below. Obviously, the drawings in the following description are only some embodiments of the present application, and other drawings may be obtained according to these drawings without any creative effort for those skilled in the art.

FIG. 1 is a schematic exploded structural diagram of a refrigerator hinge according to an embodiment of the present application.

FIG. 2 is a schematic three-dimensional cross-sectional structural diagram of a refrigerator hinge according to an embodiment of the present application.

FIG. 3 is a schematic three-dimensional structural diagram of a refrigerator hinge according to an embodiment of the present application.

FIG. 4 is a schematic exploded structural diagram of a reversing transmission assembly of a refrigerator hinge according to an embodiment of the present application.

### DETAILED DESCRIPTION

The embodiments of the present application are described in further detail below with reference to the accompanying drawings and embodiments. The following embodiments are used to illustrate the present application, but are not intended to limit the scope of the present application.

In the description of the embodiments of the present application, it should be noted that the orientation or position relationship indicated by the terms “center,” “longitudinal,” “lateral,” “up,” “down,” “front,” “back,” “left,” “right,” “vertical,” “horizontal,” “top,” “bottom,” “inside,” “outside,” etc., are the orientation or position relationship based on those shown in the accompanying drawings, are only for the convenience of describing the embodiments of the present application and simplifying the description, are not intended to indicate or imply that the device or element referred to must have a specific orientation, be constructed and operated in a specific orientation, and therefore cannot be understood as a limitation on the embodiments of the present application. Furthermore, the terms “first,” “second,” and “third” are used for descriptive purposes only, and should not be understood as indicating or implying relative importance.

In the description of the embodiments of the present application, it should be noted that unless otherwise clearly specified and limited, the terms “connected” and “connection” should be broadly understood. For example, it may be a fixed connection or a detachable connection, where the fixed connection may include an integral connection. It may be a mechanical connection or an electrical connection, and it may be a direct connection or an indirect connection via an intermediate medium. For those skilled in the art, the specific meanings of the above terms in the embodiments of the present application can be understood according to specific circumstances.

In the embodiments of the present application, unless otherwise clearly specified and limited, a first feature being “on” or “under” a second feature may mean that the first and second features are in direct contact, or the first and second features are in indirect contact via an intermediate medium. Moreover, the first feature being “above”, “over” and “on” the second feature may mean that the first feature is directly above or obliquely above the second feature, or simply means that the first feature is horizontally higher than the second feature. The first feature being “under”, “below”, and “underneath” the second feature may mean that the first feature is directly below or obliquely below the second feature, or simply means that the first feature has a lower horizontal height than the second feature.

In the description of this specification, the terms “one embodiment”, “some embodiments”, “example”, “specific example”, or “some examples” means that the specific features, structures, materials or characteristics described in conjunction with the embodiment or example are included in at least one embodiment or example of the embodiments of the present application. In this specification, the schematic expressions of the above terms do not necessarily refer to the same embodiment or example. Moreover, the specific features, structures, materials, or characteristics described may be combined in any suitable manner in any one or more embodiments or examples. Furthermore, those skilled in the art may combine and integrate different embodiments or examples and features of different embodiments or examples described in this specification without contradicting each other.

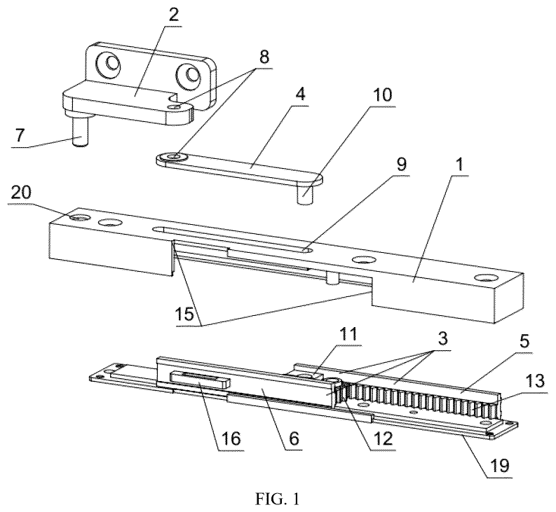

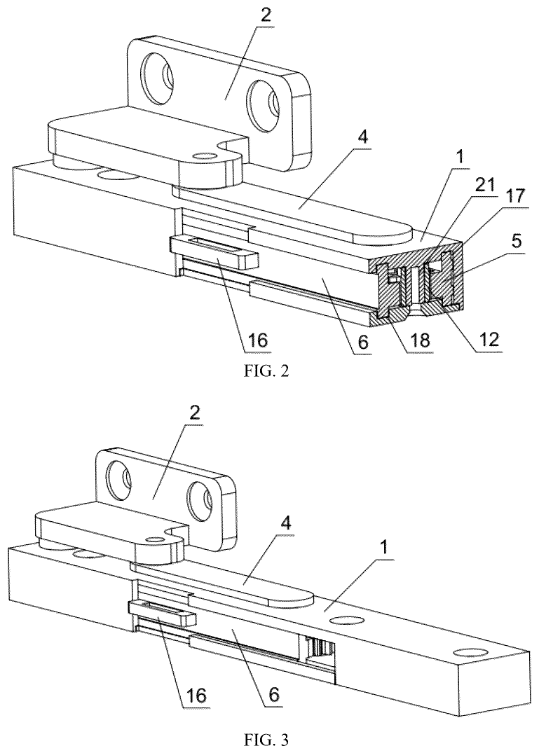

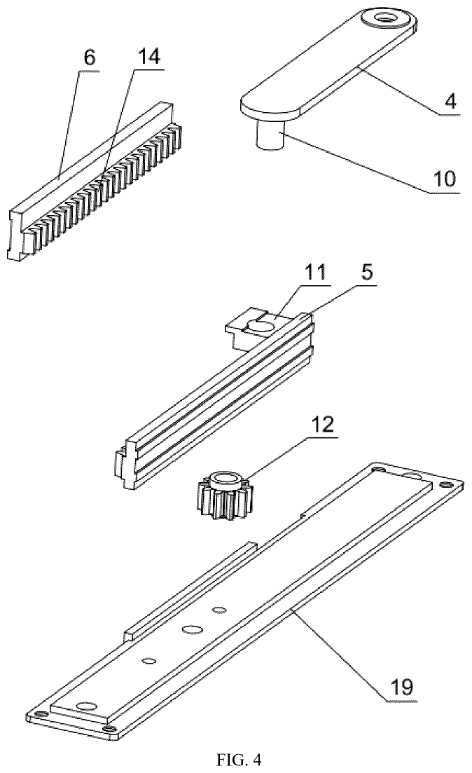

Referring to FIGS. 1 to 4, a refrigerator hinge includes a first connector 1 connected to a refrigerator door panel, a second connector 2 connected to a refrigerator cabinet, and a third connector 6 connected to a refrigerator door outer decorative panel. A transmission mechanism is provided among the first connector 1, the second connector 2, and the third connector 6. The refrigerator door outer decorative panel and the refrigerator door panel are stacked. By means of the transmission mechanism, the first connector 1 drives the refrigerator door panel to be opened or closed on the refrigerator cabinet, and by means of the transmission mechanism, the third connector 6 drives the refrigerator door outer decorative panel to slide at the refrigerator door panel during opening or closing of the refrigerator door panel.

The refrigerator door outer decorative panel overlays the outer surface of the refrigerator door panel.

In an embodiment, the second connector 2 is provided with a fixation hole for threading a screw to fix the second connector 2 to the refrigerator cabinet.

The first connector 1 is hinged to the second connector 2, and the transmission mechanism includes a rotation shaft 7 provided between the first connector 1 and the second connector 2, where the first connector 1 is rotationally positioned at the second connector 2 via the rotation shaft 7, to allow the refrigerator door panel connected to the first connector 1 to be rotationally opened or closed on the refrigerator cabinet.

The transmission mechanism further includes a link 4 provided between the first connector 1 and the second connector 2, and a reversing transmission assembly 3 matched with the link 4, where one end of the link 4 is connected to the second connector 2, the second end of the link 4 is connected to the reversing transmission assembly 3, and the reversing output end of the reversing transmission assembly 3 is connected to the third connector 6.

The link 4 and the rotation shaft 7 are provided at intervals between the first connector 1 and the second connector 2.

During the opening of the refrigerator door panel from the refrigerator cabinet via the first connector 1, the first connector 1 drives the link 4 and the reversing transmission assembly 3 to move, and the reversing output end of the reversing transmission assembly 3 acts on the third connector 6, to allow the refrigerator door outer decorative panel connected to the third connector 6 to slide at the refrigerator door panel in a direction away from the refrigerator cabinet when the refrigerator door panel is opened.

During the closing of the refrigerator door panel to the refrigerator cabinet via the first connector 1, the first connector 1 drives the link 4 and the reversing transmission assembly 3 to move, and the reversing output end of the reversing transmission assembly 3 acts on the third connector 6, to allow the refrigerator door outer decorative panel connected to the third connector 6 to slide at the refrigerator door panel in a direction close to the refrigerator cabinet when the refrigerator door panel is closed.

In an embodiment, a hinge hole 8 is provided between the first end of the link 4 and the second connector 2, and a hinge shaft is inserted through the hinge hole 8 between the first end of the link 4 and the second connector 2, to allow the first end of the link 4 to be rotatably connected with the second connector 2.

The first connector 1 is provided with a limit slide slot 9, and the second end of the link 4 is provided with a limit post 10 connected to the reversing transmission assembly 3. During the opening or closing of the refrigerator door panel from or to the refrigerator cabinet via the first connector 1, the limit post 10 of the link 4 moves in a limited manner on the limit slide slot 9 and drives the reversing transmission assembly 3 to move.

The first connector 1 is provided with an inner cavity for accommodating and mounting the reversing transmission assembly 3, and the reversing transmission assembly 3 includes a gear 12 and a slider 5, where the slider 5 and the third connector 6 are respectively in transmission connection with the gear 12, where the slider 5 is provided with a connection block 11 connected to the second end of the link 4.

During the opening or closing of the refrigerator door panel, the first connector 1 drives the link 4 and the slider 5 to move, the slider 5 moves and drives the gear 12 to rotate, and the gear 12 rotates and drives the third connector 6, to allow the refrigerator door outer decorative panel to slide at the refrigerator door panel.

The movement directions of the slider 5 and the third connector 6 are opposite, the slider 5 is provided with first meshing teeth 13 meshed with the gear 12, and the third connector 6 is provided with second meshing teeth 14 meshed with the gear 12. The slider 5 drives, when sliding, the gear 12 to rotate, and the gear 12 rotates and drives the third connector 6 and the refrigerator door outer decorative panel to slide.

A first linear slidably-connected fit position 17 is provided between the slider 5 and the first connector 1, and the slider 5 is configured to linearly slide at the first connector 1 via the first linear slidably-connected fit position 17. A second linear slidably-connected fit position 18 is provided between the third connector 6 and the first connector 1, and the third connector 6 is configured to linearly slide at the first connector 1 via the second linear slidably-connected fit position 18.

The first connector 1 is provided with a rotation post 21 fit with the gear 12, and the gear 12 is rotationally positioned at the first connector 1 via the rotation post 21 when rotating.

The first connector 1 is provided with a bottom cover 19 for packaging the gear 12, the slider 5, and the third connector 6 in the inner cavity of the first connector 1.

The first connector 1 is provided with an opening 15 at a location corresponding to the connection between the third connector 6 and the refrigerator door outer decorative panel, and the third connector 6 is provided with a fixation block 16 in fit connection with the refrigerator door outer decorative panel. The fixation block 16 slides in a limited manner within the opening 15 when the third connector 6 and the refrigerator door outer decorative panel slide.

In an embodiment, the first connector 1 is provided with an inner cavity for accommodating and mounting the slider 5, the third connector 6, and the gear 12. The inner cavity is provided with a rotation post 21, into which the shaft hole of the gear 12 is inserted.

In an embodiment, a bottom cover 19 is provided at the bottom of the first connector 1, and by means of the bottom cover 19, the slider 5, the third connector 6, and the gear 12 are encapsulated in the inner cavity of the first connector 1. The first connector 1 is fixedly connected to the bottom cover 19 by a snap or screw.

In an embodiment, buffer pads are provided at both sides of the opening 15, and the buffer pads are adhered to the side portions of the opening 15 by glue. Thus, when the refrigerator door outer decorative panel slides, the fixation block 16 contacts the buffer pads, thereby avoiding noise during the opening or closing of the refrigerator door panel.

In an embodiment, the refrigerator door outer decorative panel is provided with a mounting slot into which the fixation block 16 is inserted, and the fixation block 16 protrudes on the outer side of the first connector 1. Thus, the refrigerator door outer decorative panel and the first connector 1 are stacked, and the refrigerator door panel is fixed to the bottom of the first connector 1. A mounting hole for threading a bolt is formed at the top of the first connector 1.

Specifically, a bolt is inserted from top to bottom into the first connector 1, the bottom cover 19, and the refrigerator door panel.

A first linear slidably-connected fit position 17 is provided between the slider 5 and the first connector 1, and the slider 5 is configured to linearly slide at the first connector 1 via the first linear slidably-connected fit position 17. A second linear slidably-connected fit position 18 is provided between the third connector 6 and the first connector 1, and the third connector 6 is configured to linearly slide at the first connector 1 via the second linear slidably-connected fit position 18.

In an embodiment, the first connector 1 is provided with a first linear limit slide slot at a location corresponding to the top of the slider 5 and the third connector 6, and the slider 5 and the third connector 6 are provided with a first limit boss that is slidably matched with the first linear limit slide slot and embedded in the first linear limit slide slot.

In an embodiment, a second linear limit slide slot is provided between the first connector 1 and the bottom cover 19 at a location corresponding to the bottom of the slider 5, and a second limit boss embedded in the second linear limit slide slot is provided at the bottom of the slider 5.

In an embodiment, the bottom cover 19 is provided with a third linear limit slide slot, and the third connector 6 is provided with a third limit boss embedded in the third linear limit slide slot.

Finally, it should be noted that the above embodiments are only used to illustrate the present application, and are not intended to limit the present application. Although the present application has been described in detail with reference to the embodiments, those skilled in the art should understand that various combinations, modifications or equivalent substitutions of the technical solutions of the present application do not depart from the scope of the technical solutions of the present application and should be included in the scope of the claims of the present application.

1. A refrigerator hinge, comprising:
a first connector connected to a refrigerator door panel, a second connector connected to a refrigerator cabinet, and a third connector connected to a refrigerator door outer decorative panel,
wherein a transmission mechanism is provided among the first connector the second connector, and the third connector-5, the refrigerator door outer decorative panel and the refrigerator door panel are stacked, the first connector drives the refrigerator door panel to be opened or closed on the refrigerator cabinet by means of the transmission mechanism, and the third connector drives the refrigerator door outer decorative panel to slide at the refrigerator door panel during opening or closing of the refrigerator door panel by means of the transmission mechanism.

2. The refrigerator hinge of claim 1, wherein the first connector is hinged to the second connector, the transmission mechanism comprises a rotation shaft provided between the first connector and the second connector, and the first connector is rotationally positioned at the second connector-to allow the refrigerator door panel connected to the first connector to be rotationally opened or closed on the refrigerator cabinet.

3. The refrigerator hinge of claim 2, wherein the transmission mechanism further comprises a link provided between the first connector H and the second connector and a reversing transmission assembly matched with the link, a first end of the link is connected to the second connector a second end of the link is connected to the reversing transmission assembly, and a reversing output end of the reversing transmission assembly is connected to the third connector; and,
wherein
the link and the rotation shaft are provided at intervals between the first connector and the second connector;
during the opening of the refrigerator door panel from the refrigerator cabinet via the first connector, the first connector-drives the link and the reversing transmission assembly to move, and the reversing output end of the reversing transmission assembly acts on the third connector, to allow the refrigerator door outer decorative panel connected to the third connector to slide at the refrigerator door panel in a direction away from the refrigerator cabinet when the refrigerator door panel is opened; and
during the closing of the refrigerator door panel to the refrigerator cabinet via the first connector, the first connector-drives the link and the reversing transmission assembly to move, and the reversing output end of the reversing transmission assembly-acts on the third connector, to allow the refrigerator door outer decorative panel connected to the third connector to slide at the refrigerator door panel in a direction close to the refrigerator cabinet when the refrigerator door panel is closed.

4. The refrigerator hinge of claim 2, wherein the first connector is provided with a limit slide slot, the second end of the link is provided with a limit post connected to the reversing transmission assembly, and during the opening or closing of the refrigerator door panel from or to the refrigerator cabinet via the first connector, the limit post of the link moves in a limited manner on the limit slide slot and drives the reversing transmission assembly to move.

5. The refrigerator hinge of claim 2, wherein the first connector is provided with an inner cavity for accommodating and mounting the reversing transmission assembly, the reversing transmission assembly comprises a gear and a slider, the slider and the third connector are respectively in transmission connection with the gear, and the slider is provided with a connection block connected to the second end of the link; and
wherein during the opening or closing of the refrigerator door panel, the first connector drives the link and the slider to move, the slider moves and drives the gear to rotate, and the gear rotates and drives the third connector, to allow the refrigerator door outer decorative panel to slide at the refrigerator door panel.

6. The refrigerator hinge of claim 5, wherein movement directions of the slider and the third connector are opposite, the slider is provided with first meshing teeth meshed with the gear, the third connector is provided with second meshing teeth meshed with the gear, the slider drives, when sliding, the gear to rotate, and the gear rotates and drives the third connector and the refrigerator door outer decorative panel to slide.

7. The refrigerator hinge of claim 5, wherein a first linear slidably-connected fit position is provided between the slider and the first connector, and the slider is configured to be linearly slide at the first connector via the first linear slidably-connected fit position, and wherein a second linear slidably-connected fit position is provided between the third connector, and the first connector, and the third connector is configured to linearly slide at the first connector via the second linear slidably-connected fit position.

8. The refrigerator hinge of claim 5, wherein the first connector is provided with a rotation post fit with the gear, and the gear is rotationally positioned at the first connector via the rotation post-when being rotated.

9. The refrigerator hinge of claim 5, wherein the first connector is provided with a bottom cover-for packaging the gear, the slider and the third connector in the inner cavity of the first connector.

10. The refrigerator hinge of claim 1, wherein the first connector is provided with an opening at a location corresponding to the connection between the third connector and the refrigerator door outer decorative panel, the third connector is provided with a fixation block in fit connection with the refrigerator door outer decorative panel, and the fixation block slides in a limited manner within the opening when the third connector and the refrigerator door outer decorative panel slide.
